(19) United States
(12) Patent Application Publication
(10) Pub. No.: US 2026/0179145 A1
(43) Pub. Date: Jun. 25, 2026

(54) MARKET DATA PROCESSING METHOD, ELECTRONIC DEVICE, AND NON-TRANSITORY COMPUTER-READABLE STORAGE MEDIUM

(71) Applicant: Shenzhen Futu Network Technology Co., Ltd., Shenzhen (CN)

(72) Inventors: Baibo HUA, Shenzhen (CN); Yaojing ZHENG, Shenzhen (CN); Jian LI, Shenzhen (CN); Xiaoquan FENG, Shenzhen (CN); Yuhe QIAO, Shenzhen (CN)

(73) Assignee: Shenzhen Futu Network Technology Co., Ltd., Shenzhen (CN)

(21) Appl. No.: 19/417,585

(22) Filed: Dec. 12, 2025

Related U.S. Application Data
(63) Continuation of application No. PCT/CN2025/137542, filed on Nov. 25, 2025.

(30) Foreign Application Priority Data
Dec. 25, 2024 (CN) 202411928519.6

(51) Int. Cl. G06Q 40/04

(52) U.S. Cl. CPC G06Q 40/042

(57) ABSTRACT

A market data processing method, device, and storage medium thereof are provided. The method includes: in response to a running operation of a target quantitative strategy, acquiring a current running time, a running object, and a target time unit of market data; acquiring a resource category of the running object, determining, based on the target time unit, the resource category, and a resource category trading time schedule, whether the current running time is a start time point of the target time unit; if yes, acquiring first market data from cached data; in a case where the first market data is not real-time market data of the running object on the target time unit at the current running time, acquiring second market data from the cached data, and constructing the real-time market data based on the second market data; and performing the target quantitative strategy based on the real-time market data.

### CROSS REFERENCE TO RELATED APPLICATIONS

The present disclosure is a continuation of International Patent Application No. PCT/CN2025/137542, filed on Nov. 25, 2025, which claims priority to Chinese Patent Application No. 202411928519.6, filed on Dec. 25, 2024, both of which are herein incorporated by reference in their entireties.

### TECHNICAL FIELD

The present disclosure relates to the technical field of financial information processing, and in particular to a market data processing method, an electronic device, and a non-transitory computer-readable storage medium.

### BACKGROUND

K-line data (i.e., market data) is acquired based on the original tick-by-tick transaction data of exchanges and is provided by various data providers. Due to the large volume of K-line data and the need for frequent pushing, in order to save server costs, K-line data with different periods are separated, and K-line data with different periods are subscribed and pushed separately. However, market data transaction changes in real time, and K-line data with different periods are asynchronously calculated and asynchronously pushed, resulting in data asynchrony of tens of milliseconds when the client receives the K-line data. This leads to logical judgment errors of a quantitative strategy near the time point when a new K-line data is generated. As a result, data cannot be pushed in a timely manner at the close-line time, and K-line data with different periods cannot be synchronized. Therefore, there is an urgent need for a method to solve the above problems.

### SUMMARY

In a first aspect, a market data processing method is provided and includes: in response to a running operation of a target quantitative strategy, acquiring a current running time, a running object in the target quantitative strategy, and a target time unit of market data subscribed in the target quantitative strategy; acquiring a resource category of the running object, and determining, based on the target time unit, the resource category, and a resource category trading time schedule, whether the current running time is a start time point of the target time unit; in a case of determining that the current running time is the start time point of the target time unit, acquiring first market data of the running object with the target time unit from cached data; in a case where the first market data is not real-time market data of the running object on the target time unit at the current running time, acquiring second market data of the running object with a candidate time unit at the current running time from the cached data, and constructing the real-time market data of the running object on the target time unit at the current running time based on the second market data; and performing the target quantitative strategy based on the real-time market data of the running object on the target time unit at the current running time.

In a second aspect, an electronic device is provided and includes: a processor and a memory. The memory is configured to store executable instructions of the processor. The processor is configured to perform the method in the first aspect.

In a third aspect, a non-transitory computer-readable storage medium is provided and stores a computer program. The computer program, when executed by a processor, implements the method in the first aspect.

### BRIEF DESCRIPTION OF THE DRAWINGS

In order to make the technical solutions and the related art described in embodiments of the present disclosure more clearly, the drawings used for description of some embodiments and the related art are described. Apparently, the drawings in the following description only illustrate some embodiments of the present disclosure. For those skilled in the art, other drawings may be acquired according to the drawings without any creative work.

FIG. 1 is a flowchart of a market data processing method according to some embodiments of the present disclosure.

FIG. 2 is a structural schematic diagram of modules for processing market data according to some embodiments of the present disclosure.

FIG. 3 is a schematic diagram of a time sequence of synchronous processing of market data according to some embodiments of the present disclosure.

FIG. 4 is a schematic diagram of a time sequence of acquiring market data according to some embodiments of the present disclosure.

FIG. 5 is a flowchart of acquiring market data with a target time unit according to some embodiments of the present disclosure.

FIG. 6 is a structural schematic diagram of a market data processing apparatus according to some embodiments of the present disclosure.

FIG. 7 is a structural schematic diagram of an electronic device according to some embodiments of the present disclosure.

### DETAILED DESCRIPTION

Some embodiments of the present disclosure are described in detail below, and examples of the embodiments are illustrated in the drawings. The embodiments described below with reference to the drawings are exemplary, intended to explain the present disclosure, and should not be construed as limiting the present disclosure.

The terms “first”, “second” and the like in the specification, claims, and drawings of the embodiments of the present disclosure are configured to distinguish similar objects, and are not necessarily configured to describe a specific sequence or order. It should be understood that the data so used may be interchanged under appropriate circumstances, so that the embodiments of the present disclosure described herein may be implemented in an order other than those illustrated or described herein. Furthermore, the terms “include” and “have”, and any modification thereof are intended to cover non-exclusive inclusion. For example, a process, a method, a system, a product, or a device that may include a series of operations or units is not limited to the listed operations or units, but optionally also may include operations or units not listed, or optionally may include other operations or units inherent to the process, the method, the product, or the device.

First, some terms in the embodiments of the present disclosure are explained below to facilitate understanding by those skilled in the art.

Quantitative trading refers to a process of completing transactions using a computer technology based on pre-formulated quantitative strategies. Quantitative trading greatly reduces the impact of sentiment fluctuations of investors, reducing irrational investment decisions when the market is extremely euphoric or pessimistic.

A quantitative strategy may include a trading object, a pre-formulated trading condition, and a trading operation (such as placing an order operation, canceling an order operation, etc.) triggered after the trading condition is met. The trading condition may include, but is not limited to, a particular condition required to be met by a technical indicator related to the market data of the trading object. For example, in a case where the quantitative strategy is a moving average golden cross opening strategy, when the moving average of K-line data of the trading object specified in the quantitative strategy with a certain short period crosses above the moving average of the K-line data with a certain long period (i.e., the quantitative condition is met), then a placing a buy order operation for the trading object is performed.

K-line data (market data) is acquired based on the original tick-by-tick transaction data of exchanges. The K-line data may include multiple fields such as a highest price, a lowest price, an opening price, a closing price, a trading volume, a turnover, and a turnover rate, etc. Each time a tick-by-tick transaction occurs, the closing price, trading volume, turnover, and other fields of the latest K-line data are affected. Due to the large volume of K-line data and the need for frequent pushing, compared to other data service scenarios, K-line data pushing occupies more network bandwidth. To save server costs, K-line data with different periods are separated, and K-line data with different periods are subscribed and pushed separately. However, considering the real-time changes in market data transactions and network delays, K-line data with different periods are asynchronously calculated and asynchronously pushed, resulting in a certain degree of data asynchrony in the K-line data with different periods when the client receives the K-line data, which leads to logical judgment errors when the quantitative strategy performs the judgment of a corresponding trading condition, resulting in failure to trigger a trading operation or erroneous triggering of a trading operation. For example, near the time point when a new K-line data is generated, the lack of K-line data due to network delay leads to logical judgment errors.

For example, in a case where an order operation for the trading object is triggered when both the 5-minute K-line and the 10-minute K-line of the trading object specified by the quantitative strategy meet a preset condition. When the current running time is 10:00, which is the open-line time for the 5-minute K-line and the 10-minute K-line. The lack of K-line data of a new K-line generated by the 5-minute K-line (or 10-minute K-line) at 10:00 due to network delay leads to logical judgment errors when the quantitative strategy performs the judgment of a corresponding trading condition, causing failure to trigger the trading operation or erroneous triggering of the trading operation.

In the related art, to achieve synchronization of K-line data with different periods, a first method is combining and pushing K-line data with different periods in one package; a second method is waiting for K-line data with different periods to be collected at the start time of the K-line data; a third method is constructing K-line data with another period based on K-line data of the period. However, in the first method, the pushed K-line data includes a large amount of redundancy, resulting in high server bandwidth costs; the second method increases the delay of the close-line time of K-line data, which cannot meet the requirements of high frequency and low latency; in the third method, K-line data with periods not requested by the strategy is constructed, wasting computing resources. In addition, asynchronous K-line data with different periods may be left unprocessed, but this requires the quantitative strategy itself to handle, increasing the management difficulty of upper-layer applications, especially in the field of high-frequency trading where asynchrony of tens of milliseconds may lead to strategy judgment errors. Therefore, there is an urgent need for a method to solve the above problems.

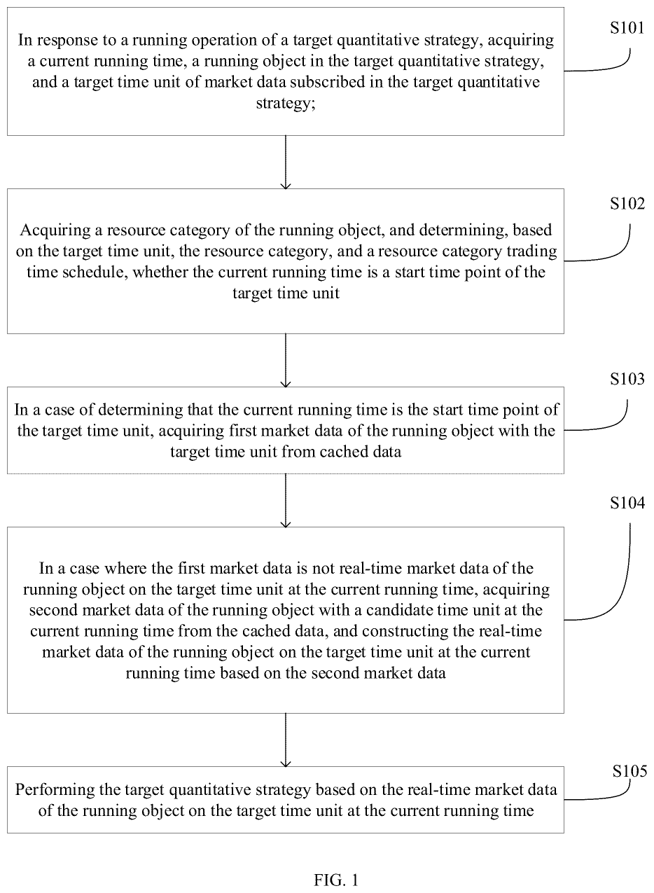

FIG. 1 is a flowchart of a market data processing method according to some embodiments of the present disclosure. The performing subject of the method may be a terminal device. The method at least includes the following operations S101-S106.

The operation S101 may include: in response to a running operation of a target quantitative strategy, acquiring a current running time, a running object in the target quantitative strategy, and a target time unit of market data subscribed in the target quantitative strategy.

In some embodiments, the terminal device is installed with an application client capable of running functions of a quantitative strategy. In a case where the client in the terminal device receives a running operation of a quantitative strategy triggered by a user, the client in the terminal device may request market data from cached data. In a case where there is no first market data or second market data in the cache data, the client waits for the background serving terminal (i.e., a server) to push the market data.

In some embodiments, the running operation of the target quantitative strategy is an operation configured to trigger performing the target quantitative strategy. For example, the running operation of the target quantitative strategy may be a click operation by the user on a button provided by the client in the terminal device for running the quantitative strategy.

In some embodiments, the target quantitative strategy may include a trading object (i.e., the running object), a pre-formulated trading condition, and a trading operation triggered after the trading condition is met. The trading object, i.e., the running object, may refer to a financial product, including but not limited to a stock, an option, or a future, etc. The trading condition may include but is not limited to a particular condition required to be met by a technical indicator related to the market data of the trading object or to the market data. After the running operation of the target quantitative strategy received, in response to the running operation, the client may acquire the market data of the trading object (i.e., the running object) from the cached data or the background serving terminal, and perform a logical judgment corresponding to the trading condition based on the market data. In a case where the trading condition is met, a corresponding trading operation is performed.

In some embodiments, the current running time refers to the time when the running operation of the target quantitative strategy is responded to. The market data refers to data information reflecting the real-time or historical trading status of the running object (such as a stock, a future, or a foreign exchange, etc.). In some embodiments, the market data may be K-line data, configured to represent price changes within a particular duration. Related content about K-line data will not be repeated here.

In some embodiments, the target time unit is configured to represent the data period of the market data. K-line data is taken as an example, the target time unit refers to a time unit for forming a K-line. For example, K-line data may include but is not limited to 1-minute K-line data, 5-minute K-line data, 1-hour K-line data, daily K-line data, and weekly K-line data, etc. The 3-minute K-line data refers to K-line data with a target time unit of 3 minutes, each K-line represents price change information within 3 minutes, i.e., the duration between the open-line time and the close-line time is 3 minutes. 5-minute K-line data refers to K-line data with a target time unit of 5 minutes, each K-line represents price change information within 5 minutes, i.e., the 5-minute market data means that the duration between the open-line time and the close-line time is 5 minutes, and so on, without listing all examples.

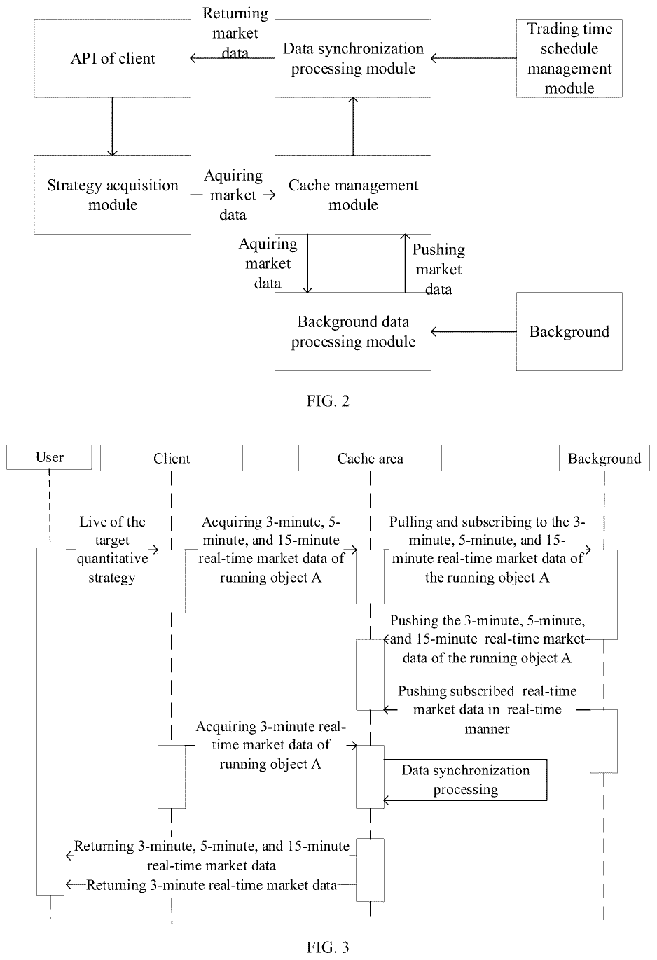

In some embodiments, as shown in FIG. 2, the information in the target quantitative strategy in the client (the running object in the target quantitative strategy and the target time unit of the market data subscribed in the target quantitative strategy) may be parsed based on interface protocol connection between the strategy acquisition module and the application programming interface (API) of the client in the server. The explanation of the interface protocol will not be repeated here.

In some embodiments, in a case where the client receives the running operation of the target quantitative strategy, the client may acquire the current running time, analyze the target quantitative strategy, and determine the running object and the target time unit of the market data used in the trading condition from the target quantitative strategy.

For example, the terminal device receives the running operation of the target quantitative strategy from the client, determines that the current running time is 10:06, analyzes the target quantitative strategy, and acquires the running object A, such as an underlying stock A, in the target quantitative strategy and a target time unit, such as 3 minutes, 5 minutes, and 15 minutes, etc., of the market data. That is, during the operation of the target quantitative strategy, 3-minute K-line data, 5-minute K-line data, and 15-minute K-line data of the underlying stock A are required.

The operation S102 may include: acquiring a resource category of the running object, and determining, based on the target time unit, the resource category, and a resource category trading time schedule, whether the current running time is a start time point of the target time unit.

In some embodiments, the resource category may include a market type of the running object and the resource type of the running object. The market type may include a Chinese market, a US market, or a European market, etc. The resource type may include but is not limited to an underlying stock, a fund, or a future, etc.

In some embodiments, the resource category trading time schedule records trading time period information corresponding to different resource types in different markets, such as a market opening time, and a market closing time, etc.

In some embodiments, as shown in FIG. 2, the resource category trading time schedule is cached and managed by a trading time schedule management module. The resource category trading time schedule may be maintained via an Excel spreadsheet. During the program initialization phase, the trading time period information corresponding to the resource category of the running object in the Excel spreadsheet is loaded and parsed. New types may be subsequently added via modifying the Excel spreadsheet.

In some embodiments, the market type and resource type of the running object in the target quantitative strategy is acquire; then, based on the market type and resource type, the corresponding trading time period information in the resource category trading time schedule is queried; then, based on the trading time period information, whether the current running time is the start time point of the target time unit of the market data subscribed in the target quantitative strategy is determined. The start time point of the target time unit may refer to an open-line time point of the market data with the target time unit subscribed in the target quantitative strategy.

It may be understood that, in a case where the current running time is the start time point of the target time unit of the market data subscribed in the target quantitative strategy, the data of market data with the target time unit on a new time period has been generated. The market data serving as K-line data is taken as an example. In a case where the current running time is the start time point of the target time unit of the K-line data subscribed in the target quantitative strategy, a new K-line of the K-line with the target time unit may be generated at the current running time, i.e., a K-line with a start time point at the current running time and a time period of the target time unit has opened, and the form of this K-line at the current running time is a horizontal bar.

In some embodiments, in the aforementioned operation S102, the operation of determining, based on the target time unit, the resource category, and a resource category trading time schedule, whether the current running time is a start time point of the target time unit may include the following operations S1021-S1023.

The operation S1021 may include: querying a market opening time corresponding to the resource category of the running object from the resource category trading time schedule.

In some embodiments, after acquiring the market type and resource type of the running object in the target quantitative strategy, the market opening time corresponding to the resource type in the corresponding market type may be found from the resource category trading time schedule.

The above example is continued to be used, and it is assumed that the resource category of the running object A is a Chinese market type and the resource type is an underlying stock type, the market opening time, such as 9:30 and 15:00, of the underlying stock in Chinese market may be found from the resource category trading time schedule.

The operation S1022 may include: acquiring a first duration between the current running time and the market opening time.

In some embodiments, in a case where there are multiple market opening times, the first duration between the current running time and the market opening time that is before the current running time and closest to the current running time is acquired.

The above example is continued to be used, the current running time is 10:06, the first duration between 9:30 and 10:06 is acquired, and the first duration is 36 minutes.

The operation S1023 may include: in a case where the target time unit multiplied by N equals the first duration, determining that the current running time is the start time point of the target time unit, and N being a positive integer greater than or equal to 1.

In some embodiments, in a case where there are multiple target time units, comparing whether a target time unit multiplied by N equals the first duration is separately performed on each target time unit, and whether the current running time is the start time point is determined for each target time unit. For a target time unit where the target time unit multiplied by N equals the first duration, it is determined that the current running time is the start time point of the target time unit. For a target time unit where the target time unit multiplied by N does not equal the first duration, it is determined that the current running time is not the start time point of the target time unit.

The above example is continued to be used, the target time units are 3 minutes, 5 minutes, and 15 minutes, and the first duration is 36 minutes. For 1 minute, 3 minutes multiplied by 12 equals 36 minutes, and 12 is a positive integer greater than 1, so that the current running time is the start time point of 3 minutes. For 5 minutes, 5 minutes multiplied by 7.2 equals 36 minutes, and 7.2 is not a positive integer, so that the current running time is not the start time point of 5 minutes. For 15 minutes, 15 minutes multiplied by 2.4 equals 36 minutes, and 2.4 is not a positive integer, so that the current running time is not the start time point of 15 minutes.

The operation S103 may include: in a case of determining that the current running time is the start time point of the target time unit, acquiring first market data corresponding to the running object and the target time unit from cached data.

The first market data refers to the latest market data cached in the cached data.

In some embodiments, in a case where the current running time is the start time point of the target time unit, the first market data of the running object with the target time unit from the cached data is acquired, and real-time market data of the running object on the target time unit at the current running time is acquired based on the first market data.

In some embodiments, as shown in FIG. 2, the cached data may be cached and managed by a cache management module.

In some embodiments, during the live running of the target quantitative strategy, the client in the terminal device subscribes to K-line data of the running object with target time unit from the background serving terminal (located on the server). After subscription, the background serving terminal continuously pushes the K-line data with the target time unit to the cache area and caches the K-line data. In a case where the first market data is required to be acquired, the first market data is first queried from the cached data in the cache area.

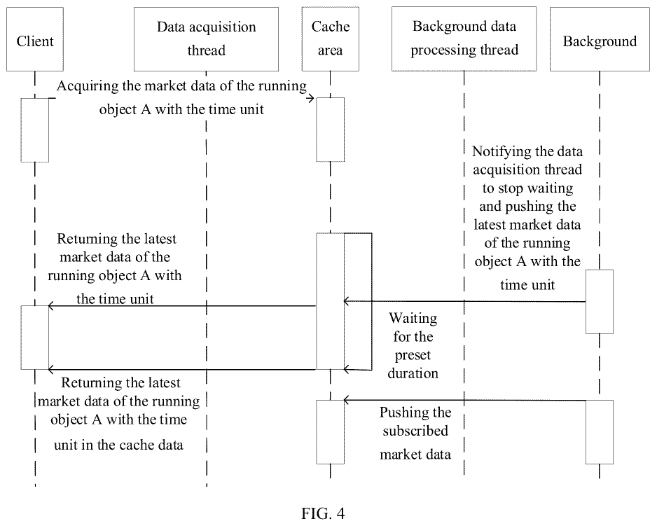

The above example is continued to be used, as shown in FIG. 3, in a case where the user triggers the live running of the target quantitative strategy via the client, the client may synchronously pull and subscribe to the 3-minute, 5-minute, and 15-minute market data of the running object A from the background serving terminal. Subsequently, the background serving terminal continuously pushes the 3-minute, 5-minute, and 15-minute market data to the client, so that the client caches this market data into the cache area, facilitating the client to acquire the subscribed real-time market data of the running object A again when the client performs the target quantitative strategy later. The client may preferentially acquire the subscribed real-time market data from the cache. In addition, other market data that is required to be sent to the client may be sent to the user after data synchronization processing. The data synchronization processing is performed by a data synchronization processing module.

In summary, the background serving terminal pushes market data to the cache of the terminal device. In a case where the market data is required to be acquired frequently, the client may directly acquire the market data from the cache without repeatedly calling the background serving terminal to acquire the market data, thereby improving the efficiency of acquiring the market data and meeting the requirements of high frequency and low latency.

In some embodiments, the method may include: in a case where the current running time is not the start time point of the target time unit, acquiring the first market data of the running object with the target time unit from the cached data; determining the first market data as the real-time market data of the running object on the target time unit at the current running time; and performing the target quantitative strategy based on the real-time market data of the running object on the target time unit at the current running time.

In some embodiments, in a case where the current running time is not the start time point of the target time unit, the first market data if the running object with the target time unit is acquired from the cached data, and this first market data is directly determined as the real-time market data of the running object on the target time unit at the current running time. Then, the target quantitative strategy is performed based on the real-time market data of the running object on the target time unit at the current running time.

The above example is continued to be used, in a case where the current running time is 10:06, the market opening time of the running object A is 9:30, and the current running time is not the open-line time of the 5-minute K-line data of the running object. In this case, the first market data, i.e., the latest data of the 5-minute K-line data in the cached data, is the K-line data of the 5-minute K-line during 10:05-10:10. In this case, this first market data may be directly pushed and determined as the real-time market data of the running object on the target time unit at the current running time to perform the target quantitative strategy. For another example, in a case where the current running time is not the open-line time of the 15-minute K-line data of the running object. In this case, the first market data, i.e., the latest data of the 15-minute K-line data in the cached data, is the K-line data of the 15-minute K-line during 10:00-10:15. In this case, this first market data may be directly pushed and determined as the real-time market data of the running object on the target time unit at the current running time to perform the target quantitative strategy.

The operation S104 may include: in a case where the first market data is not real-time market data of the running object on the target time unit at the current running time, acquiring second market data of the running object with a candidate time unit at the current running time from the cached data, and constructing the real-time market data of the running object on the target time unit at the current running time based on the second market data.

In some embodiments, in a case where the close-line time of the first market data acquired from the cache is the current running time, the first market data is not the real-time market data of the running object at the current running time.

It may be understood that, as mentioned above, in a case where the current running time is the start time point of the target time unit of the market data subscribed in the target quantitative strategy, a new market data with the target time unit has been generated at the current running time, and the logical judgment is required to be performed based on the new market data when the target quantitative strategy is performed. In a case where the first market data is not the real-time market data of the running object at the current running time, the new market data with the target time unit is missing at the current running time. Directly using this first market data will cause logical judgment errors when the quantitative strategy performs the judgment of the corresponding trading condition, causing failure to trigger the trading operation or erroneous triggering of the trading operation.

In some embodiments, the candidate time unit refers to a time unit shorter than the time unit of the first market data. In some embodiments, the market data with the candidate time unit may be configured to construct the market data with the target time unit. The market data serving as K-line data is taken as an example, 1-minute K-line data may be configured to construct 3-minute K-line data, and 3-minute K-line data may be configured to construct 15-minute K-line data.

In some embodiments, the second market data is the real-time market data of the running object on the candidate time unit at the current running time.

In some embodiments, for the target time unit of the market data subscribed in the target quantitative strategy, a candidate time unit corresponding to the target time unit may be preset. In some embodiments, before the operation of acquiring the first market data of the running object with the target time unit from the cached data, the method may include: acquiring a candidate time unit matched with the target time unit; determining a cache parameter based on the candidate time unit; acquiring target market data of the running object with the target time unit from the background serving terminal, and storing the target market data in a first cache area; acquiring candidate market data of the running object with the candidate time unit from the background serving terminal, and storing the candidate market data in a second cache area. The second cache area is configured to store the candidate market data based on the cache parameter. The cache parameter may include a cache refresh frequency configured to indicate the second cache area.

It may be understood that the aforementioned target market data and candidate market data are both stored as cached data in the cache area (including the first cache area and the second cache area). Acquiring the first market data of the running object with the target time unit from the cached data may include acquiring the first market data of the running object with the target time unit from the cached data in the first cache area. Acquiring the second market data of the running object with the candidate time unit at the current running time from the cached data may include acquiring the second market data of the running object with the candidate time unit from the cached data in the second cache area. In addition, the cache refresh frequency of the second cache area is different from that of the first cache area. Since the candidate market data is not the market data actually used in the quantitative strategy, the cache refresh frequency of the second cache area may be greater than that of the first cache area. A high refresh frequency ensures that the candidate market data with the candidate time unit stored continuously in the second cache area is the latest data, while historical data is deleted to save storage space. Furthermore, the cache parameter may be inversely proportional to the candidate time unit, i.e., the longer the candidate time unit is, the smaller the cache parameter is, and the shorter the candidate time unit is, the larger the cache parameter is.

Furthermore, in a case where the target market data is stored, multiple storage media and corresponding storage methods may be set. For example, the multiple storage media may include memories, hard disk media, and cloud storage media, etc. Based on the time point of the target market data, the target market data may be cached to different storage media in different storage methods. In some embodiments, the running duration Tie of the target quantitative strategy, the time point Tmom(i) of the target market data, the current running time Tcurr, and other information may be acquired. Based on the above information, the storage parameter of the target market data is calculated as:

$$w = \frac{( Tcurr - Tmom ( i ) )}{Tie} * {e}^{- ( Tcurr - Tmom ( i ) )}$$

Where w represents an importance degree of the i^{th} target market data, and (Tcurr−Tmom(i)) represents the length of the time interval between the time point of the i^{th} target market data and the current running time. During this running process of the target quantitative strategy, the importance of the i^{th} target market data is inversely proportional to the length of the time interval between the time point of the i^{th} target market data and the current running time, and further decreases as the running duration Tie increases. After acquiring the storage parameter w of the i^{th} target market data through the above method, the storage medium and storage method are determined based on a parameter threshold range of the storage parameter w. For example, the larger the storage parameter w is, the higher the importance degree of the i^{th} target market data is, the higher the probability that the target quantitative strategy uses this data is, so that the i^{th} target market data may be stored in a storage medium, such as memory used for caching, with faster access speed to improve the access speed of this market data. The smaller the storage parameter w is, the lower the importance degree of the i^{th} target market data is, the lower the probability that the target quantitative strategy uses this data is, so that the i^{th} target market data may be stored in a storage medium, such as hard disk media or cloud storage media, with slower access speeds.

The target market data with the target time unit serves as the cached data, and is stored, based on importance degree, in the first cache area constructed with different storage media, so that the storage efficiency of market data and the efficiency of data acquisition are improved, thereby improving the running efficiency of the target quantitative strategy.

In some embodiments, as shown in FIG. 2, the data synchronization processing module may determine, based on the trading time schedule management module, whether the current running time is the open-line time of the target time unit and whether the market data in the current cache is the latest market data with the target time unit.

The above example is continued to be used, as shown in FIG. 2 and FIG. 3, for the market data with a target time unit of 3 minutes, i.e., the K-line data of the 3-minute K-line, the data synchronization processing module acquires the first market data during the duration 10:03-10:06, and the current running time is also 10:06, which indicates that the first market data acquired from the cache is not K-line data (i.e., the real-time market data with the target time unit) of the new K-line generated by the 3-minute K-line of running object A at 10:06. In this case, K-line data (i.e., the second market data) of the new K-line generated by the 1-minute K-line of running object A at 10:06 may be acquired from the cached data, and is configured to construct the K-line data of the new K-line generated by the 3-minute K-line at 10:06.

In some embodiments, as shown in FIG. 2, a method for constructing the market data with the target time unit is set in the data synchronization processing module. The real-time market data of the running object on the target time unit at the current running time is constructed based on the acquired latest second market data. Contents related to constructing K-line data with another period based on K-line data with different periods will not be repeated here. The data synchronization processing process in FIG. 2 is performed in the data synchronization processing module.

For example, in a case where the current time is 10:00, K-line data of a new K-line generated by 5-minute K-line of the running object has been acquired, but K-line data of a new K-line generated by the 10-minute K-line is missing. In this case, the latest K-line data of the 5-minute K-line of the running object A may be configured to construct the latest K-line data of the 10-minute K-line of the running object A, so that the corresponding real-time market data is acquired.

In summary, K-line data with another period (the candidate time unit) and the open-line time at the current running time is acquired, so that the real-time market data with the target time unit and the open-line time at the current running time is constructed, ensuring that the acquired real-time market data with the target time unit is the latest data, ensuring that data with different periods are synchronized. Only the real-time market data with the target time unit required by the client is constructed, without constructing the real-time market data of the running object with all time units, thereby saving a lot of computing resources.

In some embodiments, in the aforementioned operation S104, the operation of constructing the real-time market data of the running object on the target time unit at the current running time based on the second market data may include the following operations S1051-S1052.

The operation S1051 may include: acquiring an opening price, a highest price, a lowest price, a closing price, and a trading volume of the second market data;

The operation S1052 may include: constructing the real-time market data of the running object on the target time unit at the current running time based on the opening price, the highest price, the lowest price, the closing price, and the trading volume.

In some embodiments, how to construct the real-time market data of the running object on the target time unit at the current running time based on the opening price, the highest price, the lowest price, the closing price, and the trading volume will not be repeated here.

In some embodiments, the method may include the following operations: in a case of not acquiring the second market data of the running object with the candidate time unit at the current running time from the cached data, entering a waiting state until acquiring the real-time market data of the running object on the target time unit at the current running time, and performing the target quantitative strategy based on the real-time market data of the running object on the target time unit at the current running time.

In some embodiments, as shown in FIG. 2, a method for synchronously waiting for the background serving terminal to push the market data with the target time unit is set in the K-line data synchronization processing module. In some embodiments, the real-time market data with the target time unit is acquired based on setting a waiting state. Based on setting a waiting state with an ignorable duration, the latest real-time market data with the target time unit is acquired, reducing the problem of unsynchronized real-time market data of the same running object with different time units sent to the client. In this way, synchronization of real-time market data with different time units during an ignorable waiting duration is achieved, meeting the requirements of scenarios with high timeliness requirements.

In some embodiments, the method may include: in a case of not acquiring the second market data of the running object and the candidate time unit at the current running time from the cached data, entering the waiting state until acquiring third market data of the running object and the candidate time unit at the current running time, constructing the real-time market data of the running object on the target time unit at the current running time based on the third market data, and performing the target quantitative strategy based on the real-time market data of the running object on the target time unit at the current running time.

In some embodiments, the entering the waiting state may include: starting timing and repeatedly detecting whether the real-time market data of the running object on the target time unit at the current running time exists; in a case where the real-time market data of the running object on the target time unit at the current running time exists, determining that the real-time market data of the running object with the target time unit at the current running time has been acquired; or repeatedly detecting whether fourth market data with the candidate time unit and a start time at the current running time exists; in a case where the fourth market data with the candidate time unit and a start time at the current running time exists, determining that the third market data of the running object with the candidate time unit at the current running time has been acquired, the fourth market data being the third market data.

The operation S105 may include: performing the target quantitative strategy based on the real-time market data of the running object on the target time unit at the current running time.

After acquiring the real-time market data of the running object on the target time unit, the performing the target quantitative strategy is triggered. In some embodiments, performing the target quantitative strategy may include: acquiring technical indicator data indicated by the trading condition in the target quantitative strategy based on the real-time market data on the target time unit, comparing whether the technical indicator data meets the particular condition indicated by the trading condition, in a case where the technical indicator corresponding to the running object meets the particular condition indicated by the trading condition in the target quantitative strategy, performing the trading operation triggered after the trading condition is met in the target quantitative strategy. For example, in a case where the target quantitative strategy is a moving average golden cross opening strategy, after the real-time market data, such as daily K-line data, of the running object is acquired, 5-day moving average data and 20-day moving average data of the running object may be acquired based on the daily K-line, and then whether the moving average chart corresponding to the 5-day moving average data crosses above the moving average chart corresponding to the 20-day moving average data is determined. In a case where the moving average chart corresponding to the 5-day moving average data crosses above the moving average chart corresponding to the 20-day moving average data, the trading operation, such as a placing a buy order operation, triggered by the trading condition is performed.

In some embodiments, the method may include: in a case of detecting that a duration of entering the waiting state has exceeded a preset duration, ending the waiting state, taking the first market data as the real-time market data of the running object on the target time unit at the current running time, and performing the target quantitative strategy based on the real-time market data of the running object on the target time unit at the current running time.

In some embodiments, the preset duration may be set based on the actual situation, for example, the preset duration may be set as a preset duration of 2 seconds.

In some embodiments, in a case where the duration of the waiting state has exceeded the preset duration, it is defaulted that the market has entered a closed state, then the waiting state is ended, and the latest market data of the running object with the target time unit in the cached data is returned.

In some embodiments, to improve the efficiency of acquiring the market data with the target time unit, a multi-threaded processing mode may be configured to acquire data. For example, a data acquisition thread and a background data processing thread are provided. The data acquisition thread is configured to push the market data with the target time unit required by the client to the client and perform delayed waiting. The background data processing thread is configured to notify the data acquisition thread to cancel the delayed waiting and push the market data to the cache area.

In some embodiments, as shown in FIG. 2, the background data processing thread is managed by a background data processing module, and is configured to handle protocol interfacing with the background, pull data, process pushed data, and parse data into quantitative internal data and store the quantitative internal data in the cache.

For example, as shown in FIG. 4, FIG. 4 is a schematic diagram of a time sequence of acquiring market data according to some embodiments of the present disclosure. The data acquisition thread acquires the latest market data of the running object with the time unit A required by the client from the cache area. In a case where the latest market data of the running object with the time unit A is not acquired, the data acquisition thread enters delayed waiting. The background data processing thread is configured to acquire the latest market data with the time unit A from the background serving terminal. In a case where the real-time market data with the target time unit or the third market data of the running object with the candidate time unit at the current running time is acquired within the preset duration, the background data processing thread notifies the data acquisition thread to stop waiting, pushes the real-time market data with the target time unit or the real-time market data with the target time unit constructed based on the third market data to the cache, and the data acquisition thread pushes the real-time market data with the target time unit to the client. In a case where the real-time market data with the target time unit and the third market data of the running object with the candidate time unit at the current running time is not acquired within the preset duration, the background data processing thread notifies the data acquisition thread to stop waiting, and the data acquisition thread pushes the latest market data with the target time unit in the cache to the client. The latest market data with the target time unit in the cache refers to the market data with the time period whose close-line time is the current running time or a time before the current running time, and this time period is the latest time period recorded in the cache. In addition, the background data processing thread may process background data in real time and push the subscribed market data to the cache in real time.

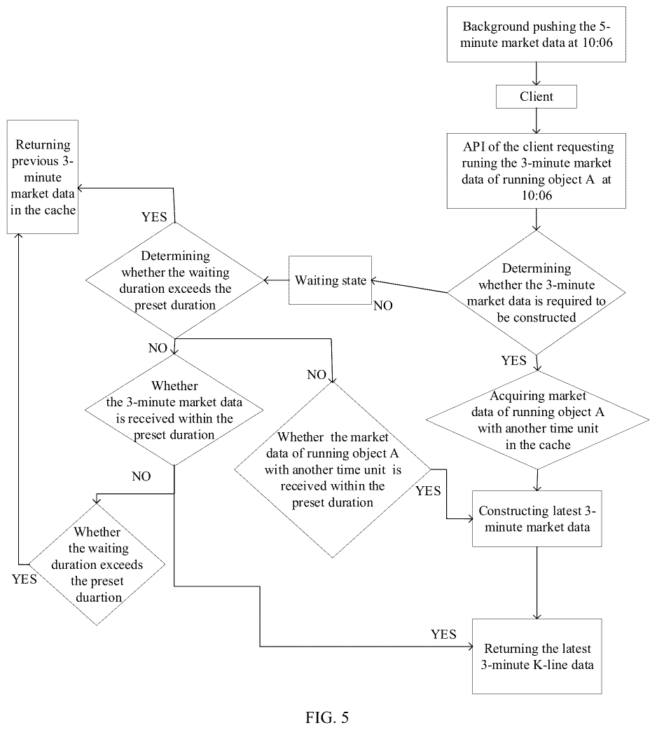

In some embodiments, as shown in FIG. 5, FIG. 5 is a flowchart of acquiring market data with a target time unit according to some embodiments of the present disclosure.

The background serving terminal continuously pushes the market data subscribed by the client. For example, at 10:06, the background serving terminal pushes the 5-minute market data subscribed by the client. In a case where market data requested by an API of the client is received, it is first determined whether this market data is required to be constructed; in a case where this market data is required to be constructed, construction processing is performed; in a case where this market data is not required to be constructed, the waiting state is entered. For example, in a case where the 3-minute market data of running object A requested by an API of the client is received at 10:06, it is first determined whether the 3-minute market data of running object A is required to be constructed; in a case where there is no latest 3-minute market data of running object A in the cache, but there is the latest market data of running object A with another time unit, it is determined that construction is required, and the 3-minute market data is constructed based on the latest market data with another time unit and returned to the client.

After entering the waiting state, it is determined whether the waiting duration exceeds the preset duration. In a case where the waiting duration does not exceed the preset duration, it is determined whether the latest 3-minute market data exists in the cache; in a case where the latest 3-minute market data exists in the cache, the latest 3-minute market data is directly returned to the client. In some embodiments, it is determined whether the market data of running object A with another time unit exists in the cache, in a case where the market data of running object A with another time unit exists in the cache, the 3-minute market data is directly constructed based on the latest market data with another time unit and returned to the client.

In a case where the waiting duration exceeds the preset duration, previous 3-minute market data in the cache is directly returned to the client. The previous 3-minute market data in the cache refers to the market data with the open-line time closest to the current running time.

In summary, the solutions provided by some embodiments of the present disclosure include: in response to a running operation of a target quantitative strategy, acquiring a current running time, a running object in the target quantitative strategy, and a target time unit of market data subscribed in the target quantitative strategy; acquiring a resource category of the running object, and determining, based on the target time unit, the resource category, and a resource category trading time schedule, whether the current running time is a start time point of the target time unit; in a case of determining that the current running time is the start time point of the target time unit, acquiring first market data of the running object with the target time unit from cached data; in a case where the first market data is not the real-time market data of the running object on the target time unit at the current running time, acquiring second market data of the running object with a candidate time unit at the current running time from the cached data, and constructing the real-time market data of the running object on the target time unit at the current running time based on the second market data; performing the target quantitative strategy based on the real-time market data of the running object on the target time unit at the current running time. The target real-time market data is constructed based on generated market data, thereby reducing constructing unnecessary market data (i.e., reducing constructing market data not requested by the target quantitative strategy), reducing wasting computing resources, not waiting for all market data related to the running object, and ensuring that the market data related to the running object is synchronized at each moment. The target quantitative strategy is performed only based on the target real-time market data, thereby saving considerable server bandwidth costs, and avoiding performing the target quantitative strategy based on all market data related to the running object, which would result in excessive redundant information and higher costs. In this way, synchronization of market data is achieved while delay at the close-line time of market data does not occur and bandwidth resources and computing resources are saved.

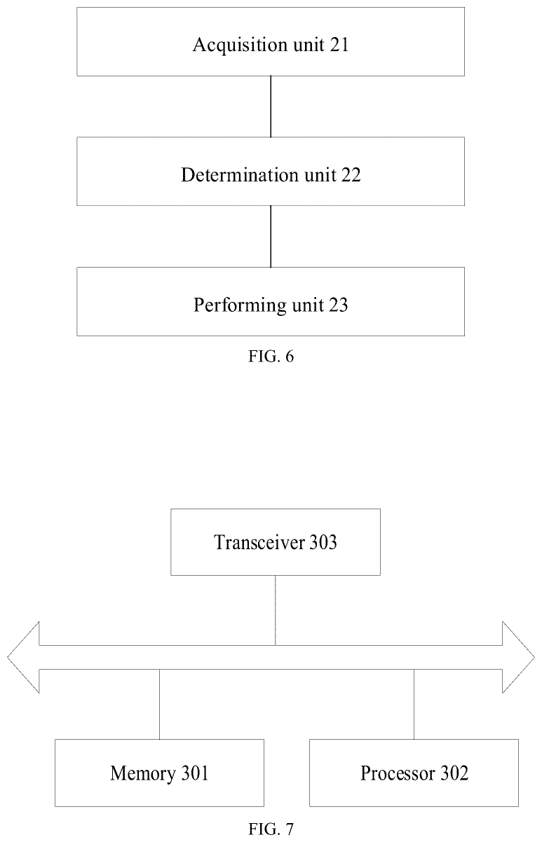

FIG. 6 is a structural schematic diagram of a market data processing according to some embodiments of the present disclosure. The apparatus may include: an acquisition unit 21, a determination unit 22, and a performing unit 23.

The acquisition unit 21 is configured to: in response to a running operation of a target quantitative strategy, acquire a current running time, a running object in the target quantitative strategy, and a target time unit of market data subscribed in the target quantitative strategy.

The determination unit 22 is configured to: acquire a resource category of the running object, and determine, based on the target time unit, the resource category, and a resource category trading time schedule, whether the current running time is a start time point of the target time unit.

The acquisition unit 21 is further configured to: in a case of determining that the current running time is the start time point of the target time unit, acquire first market data of the running object with the target time unit from cached data.

The acquisition unit 21 is further configured to: in a case where the first market data is not the real-time market data of the running object on the target time unit at the current running time, acquiring second market data of the running object with a candidate time unit at the current running time from the cached data, and constructing the real-time market data of the running object on the target time unit at the current running time based on the second market data.

The performing unit 23 is configured to: perform the target quantitative strategy based on the real-time market data of the running object on the target time unit at the current running time.

In some embodiments, the apparatus is further configured to: in a case where the current running time is not the start time point of the target time unit, acquire first market data of the running object with the target time unit from the cached data; determine the first market data as the real-time market data of the running object on the target time unit at the current running time; and perform the target quantitative strategy based on the real-time market data of the running object on the target time unit at the current running time.

In some embodiments, the apparatus is further configured to: in a case not of acquiring the second market data of the running object with the candidate time unit at the current running time from the cached data, enter a waiting state until acquiring the real-time market data of the running object on the target time unit at the current running time, and perform the target quantitative strategy based on the real-time market data of the running object on the target time unit at the current running time; or until acquiring third market data of the running object with the candidate time unit at the current running time, construct the real-time market data of the running object on the target time unit at the current running time based on the third market data, and perform the target quantitative strategy based on the real-time market data of the running object on the target time unit at the current running time.

In some embodiments, the apparatus, when configured to enter the waiting state, is configured to: start timing and repeatedly detect whether the real-time market data with a duration of the target time unit and a start time at the current running time exists; in a case where the real-time market data with the duration of the target time unit and the start time at the current running time exists, determine that the real-time market data of the running object with the target time unit at the current running time has been acquired; or repeatedly detect whether fourth market data with a duration of the candidate time unit and a start time at the current running time exists; in a case where the fourth market data with the duration of the candidate time unit and a start time at the current running time exists, determine that the third market data of the running object with the candidate time unit at the current running time has been acquired, the fourth market data is the third market data.

In some embodiments, the apparatus is configured to: in a case of detecting that the duration of entering the waiting state has exceeded a preset duration, end the waiting state, take the first market data as the real-time market data of the running object on the target time unit at the current running time, and perform the target quantitative strategy based on the real-time market data of the running object on the target time unit at the current running time.

In some embodiments, the apparatus, when configured to determine, based on the target time unit, the resource category, and a resource category trading time schedule, whether the current running time is a start time point of the target time unit, is configured to: query a market opening time corresponding to the resource category of the running object from the resource category trading time schedule; acquire a first duration between the current running time and the market opening time; in a case where the target time unit multiplied by N equals the first duration, determine that the current running time is the start time point of the target time unit, and N is a positive integer greater than or equal to 1.

It should be understood that the apparatus embodiments and the method embodiments may correspond to each other, and similar descriptions may refer to the method embodiments. To avoid repetition, details are not repeated here. In some embodiments, the apparatus may perform the above method embodiments, and the foregoing and other operations and/or functions of the modules in the apparatus are respectively configure to implement the corresponding processes in the methods of the above method embodiment. For brevity, details are not repeated here.

The above describes the apparatus of some embodiments of the present disclosure from the perspective of functional modules in combination with the drawings. It should be understood that the functional modules may be implemented in hardware, may be implemented by instructions in the form of software, or may be implemented by a combination of hardware and software modules. In some embodiments, the operations of the method embodiments in the embodiments of the present disclosure may be completed via logic circuits in the hardware of a processor and/or instructions in software form. The operations of the methods disclosed in the embodiments of the present disclosure may be directly embodied as being performed and completed by a hardware decoding processor, or performed and completed by a combination of hardware and software modules in the decoding processor. In some embodiments, the software modules may be located in mature storage media in the field such as random access memory, a flash memory, a read-only memory, a programmable read-only memory, an electrically erasable programmable memory, a register. The storage medium is located in the memory, and the processor reads the information in the memory and completes the operations in the above method embodiments in combination with the hardware.

FIG. 7 is a structural schematic diagram of an electronic device according to some embodiments of the present disclosure. The electronic device may include: a memory 301 and a processor 302.

The memory 301 is configured to store a computer program and transmit the program code to the processor 302. In other words, the processor 302 may call and run the computer program from the memory 301 to implement the method in the embodiments of the present disclosure.

For example, the processor 302 may be configured to perform the above method embodiments according to the instructions in the computer program.

In some embodiments of the present disclosure, the processor 302 may include but is not limited to a general-purpose processor, a digital signal processor (DSP), an application specific integrated circuit (ASIC), a field programmable gate array (FPGA) or other programmable logic devices, a discrete gate or transistor logic device, or a discrete hardware component, etc.

In some embodiments of the present disclosure, the memory 301 may include but is not limited to transitory memory and/or a non-transitory memory. The non-transitory memory may include a read-only memory (ROM), a programmable read-only memory (PROM), an erasable programmable read-only memory (EPROM), an electrically erasable programmable read-only memory (EEPROM) or a flash memory. The transitory memory may include a random access memory (RAM), which is used as an external cache. By way of illustrative but not restrictive description, many forms of RAM are available, such as a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synch link dynamic random access memory (SLDRAM) and a direct rambus random access memory (DR RAM).

In some embodiments of the present disclosure, the computer program may be divided into one or more modules, and the one or more modules are stored in the memory 301 and performed by the processor 302 to complete the method provided by the embodiments of the present disclosure. The one or more modules may be a series of computer program instruction segments capable of completing specific functions, and the instruction segments are configured to describe the execution process of the computer program in the electronic device.

As shown in FIG. 7, the electronic device may further include a transceiver 303.

The transceiver 303 may be connected to the processor 302 or the memory 301.

The processor 302 may control the transceiver 303 to communicate with other devices. In some embodiments, the transceiver 303 may send information or data to other devices, or receive information or data sent by other devices. The transceiver 303 may include a transmitter and a receiver. The transceiver 303 may further include an antenna, and the number of antennas may be one or more.

It should be understood that the various components in the electronic device are connected through a bus system, and the bus system may include a data bus in addition to a power bus, a control bus, and a status signal bus.

Some embodiments of the present disclosure also provide a non-transitory computer-readable storage medium storing a computer program, and the computer program, when performed by a computer, causes the computer to perform the method of the above method embodiments. In other words, some embodiments of the present disclosure also provide a computer program product including instructions, which when performed by a computer, cause the computer to perform the method of the above method embodiments.

When implemented in software, the method may be implemented entirely or partially in the form of a computer program product. The computer program product may include one or more computer instructions. When the computer program instructions are loaded and performed on a computer, the processes or functions described in the embodiments of the present disclosure are entirely or partially generated. The computer may be a general-purpose computer, a special-purpose computer, a computer network, or other programmable devices. The computer instructions may be stored in a computer-readable storage medium or transmitted from one computer-readable storage medium to another computer-readable storage medium. For example, the computer instructions may be transmitted from a website, computer, server, or data center to another website, computer, server, or data center via wired (such as coaxial cable, optical fiber, digital subscriber line (DSL)) or wireless (such as infrared, wireless, microwave, etc.) means. The computer-readable storage medium may be any available medium that may be accessed by a computer or a data storage device such as a server or data center integrated with one or more available media. The available medium may be a magnetic medium (e.g., floppy disk, hard disk, magnetic tape), an optical medium (e.g., digital video disc (DVD)), or a semiconductor medium (e.g., solid state disk (SSD)), etc.

Those skilled in the art may realize that the units and algorithm operations of each example described in combination with some embodiments described herein may be implemented by an electronic hardware, or a combination of a computer software and an electronic hardware. Whether these functions are implemented in a hardware or a software depends on a specific application and design constraints of the technical solutions. A professional and technical personnel may use different methods for each specific application to implement the described functions, but such implementation should not be considered beyond the scope of the present disclosure.

In some embodiments provided herein, it should be understood that the disclosed systems, apparatuses, and methods may be implemented in other ways. For example, the device embodiments described above are merely illustrative. For example, the division of the above units is only a logical function division. In actual implementation, there may be another division manner. For example, multiple units or components may be combined or integrated into another system, or some features can be ignored or not executed. In addition, the mutual coupling or direct coupling or communication connection shown or discussed may be an indirect coupling or communication connection through some interfaces, devices or units, and may be electrical or in other forms.

The units described above as separate components may or may not be physically separated, and the components illustrated as units may or may not be physical units. The units may be located in one place, or may be distributed to multiple network units. Some or all of the units may be selected according to actual needs to achieve the purpose of a solution of the embodiments. For example, the functional modules in the various embodiments of the present disclosure may be integrated into one processing module, or each module may exist physically alone, or two or more modules may be integrated into one module.

The above are only some implementations of the present disclosure, but the scope of the present disclosure is not limited thereto. Those skilled in the art may easily think of changes or substitutions within the scope disclosed in the present disclosure, which should be covered by the protection scope of the present disclosure. Therefore, the scope of the present disclosure should be subject to the scope of the claims.

1. A market data processing method, comprising:
in response to a running operation of a target quantitative strategy, acquiring a current running time, a running object in the target quantitative strategy, and a target time unit of market data subscribed in the target quantitative strategy;
acquiring a resource category of the running object, and determining, based on the target time unit, the resource category, and a resource category trading time schedule, whether the current running time is a start time point of the target time unit;
in a case of determining that the current running time is the start time point of the target time unit, acquiring first market data of the running object with the target time unit from cached data;
in a case where the first market data is not real-time market data of the running object on the target time unit at the current running time, acquiring second market data of the running object with a candidate time unit at the current running time from the cached data, and constructing the real-time market data of the running object on the target time unit at the current running time based on the second market data; and
performing the target quantitative strategy based on the real-time market data of the running object on the target time unit at the current running time.

2. The method according to claim 1, further comprising:
in a case where the current running time is not the start time point of the target time unit, acquiring the first market data of the running object with the target time unit from the cached data;
determining the first market data as the real-time market data of the running object on the target time unit at the current running time; and
performing the target quantitative strategy based on the real-time market data of the running object on the target time unit at the current running time.

3. The method according to claim 1, further comprising:
in a case of not acquiring the second market data of the running object and the candidate time unit at the current running time from the cached data, entering a waiting state until acquiring the real-time market data of the running object on the target time unit at the current running time, and performing the target quantitative strategy based on the real-time market data of the running object on the target time unit at the current running time; or
in a case of not acquiring the second market data of the running object and the candidate time unit at the current running time from the cached data, entering the waiting state until acquiring third market data of the running object and the candidate time unit at the current running time, constructing the real-time market data of the running object on the target time unit at the current running time based on the third market data, and performing the target quantitative strategy based on the real-time market data of the running object on the target time unit at the current running time.

4. The method according to claim 3, wherein entering the waiting state comprises:
starting timing and repeatedly detecting whether the real-time market data of the running object on the target time unit at the current running time exists; in a case where the real-time market data of the running object on the target time unit at the current running time exists, determining that the real-time market data of the running object with the target time unit at the current running time has been acquired; or
starting timing and repeatedly detecting whether the third market data of the running object with the candidate time unit at the current running time exists; in a case where the third market data of the running object with the candidate time unit at the current running time exists, determining that the third market data of the running object with the candidate time unit at the current running time has been acquired.

5. The method according to claim 3, further comprising: in a case of detecting that a duration of entering the waiting state has exceeded a preset duration, ending the waiting state, taking the first market data as the real-time market data of the running object on the target time unit at the current running time, and performing the target quantitative strategy based on the real-time market data of the running object on the target time unit at the current running time.

6. The method according to claim 1, wherein determining, based on the target time unit, the resource category, and the resource category trading time schedule, whether the current running time is the start time point of the target time unit, comprises:
querying a market opening time corresponding to the resource category of the running object from the resource category trading time schedule;
acquiring a first duration between the current running time and the market opening time; and
in a case where the target time unit multiplied by N equals the first duration, determining that the current running time is the start time point of the target time unit, and N being a positive integer greater than or equal to 1.

7. The method according to claim 1, wherein before acquiring first market data of the running object with the target time unit from cached data, the method comprises:
acquiring the candidate time unit matched with the target time unit; determining a cache parameter based on the candidate time unit; acquiring the first market data of the running object with the target time unit from a background serving terminal, storing the first market data in a first cache area; acquiring candidate market data of the running object with the candidate time unit from the background serving terminal, and storing the candidate market data in a second cache area;
wherein the second cache area is configured to store the candidate market data based on the cache parameter, the cache parameter comprises a cache refresh frequency configured to indicate the second cache area, and the cache refresh frequency of the second cache area is greater than a cache refresh frequency of the first cache area.

8. The method according to claim 1, wherein constructing the real-time market data of the running object on the target time unit at the current running time based on the second market data comprises:
acquiring an opening price, a highest price, a lowest price, a closing price, and a trading volume of the second market data; and
constructing the real-time market data of the running object on the target time unit at the current running time based on the opening price, the highest price, the lowest price, the closing price, and the trading volume.

9. An electronic device, comprising:
a processor; and
a memory, configured to store executable instructions of the processor;
wherein the processor is configured to perform a market data processing method, and the market data processing method comprises:
in response to a running operation of a target quantitative strategy, acquiring a current running time, a running object in the target quantitative strategy, and a target time unit of market data subscribed in the target quantitative strategy;
acquiring a resource category of the running object, and determining, based on the target time unit, the resource category, and a resource category trading time schedule, whether the current running time is a start time point of the target time unit;
in a case of determining that the current running time is the start time point of the target time unit, acquiring first market data of the running object with the target time unit from cached data;
in a case where the first market data is not real-time market data of the running object on the target time unit at the current running time, acquiring second market data of the running object with a candidate time unit at the current running time from the cached data, and constructing the real-time market data of the running object on the target time unit at the current running time based on the second market data; and
performing the target quantitative strategy based on the real-time market data of the running object on the target time unit at the current running time.

10. The electronic device according to claim 9, wherein the market data processing method further comprises:
in a case where the current running time is not the start time point of the target time unit, acquiring the first market data of the running object with the target time unit from the cached data;
determining the first market data as the real-time market data of the running object on the target time unit at the current running time; and
performing the target quantitative strategy based on the real-time market data of the running object on the target time unit at the current running time.

11. The electronic device according to claim 9, wherein the market data processing method further comprises:
in a case of not acquiring the second market data of the running object and the candidate time unit at the current running time from the cached data, entering a waiting state until acquiring the real-time market data of the running object on the target time unit at the current running time, and performing the target quantitative strategy based on the real-time market data of the running object on the target time unit at the current running time; or
in a case of not acquiring the second market data of the running object and the candidate time unit at the current running time from the cached data, entering the waiting state until acquiring third market data of the running object and the candidate time unit at the current running time, constructing the real-time market data of the running object on the target time unit at the current running time based on the third market data, and performing the target quantitative strategy based on the real-time market data of the running object on the target time unit at the current running time.

12. The electronic device according to claim 11, wherein entering the waiting state comprises:
starting timing and repeatedly detecting whether the real-time market data of the running object on the target time unit at the current running time exists; in a case where the real-time market data of the running object on the target time unit at the current running time exists, determining that the real-time market data of the running object with the target time unit at the current running time has been acquired; or
starting timing and repeatedly detecting whether the third market data of the running object with the candidate time unit at the current running time exists; in a case where the third market data of the running object with the candidate time unit at the current running time exists, determining that the third market data of the running object with the candidate time unit at the current running time has been acquired.

13. The electronic device according to claim 11, wherein the market data processing method further comprises: in a case of detecting that a duration of entering the waiting state has exceeded a preset duration, ending the waiting state, taking the first market data as the real-time market data of the running object on the target time unit at the current running time, and performing the target quantitative strategy based on the real-time market data of the running object on the target time unit at the current running time.

14. The electronic device according to claim 9, wherein determining, based on the target time unit, the resource category, and the resource category trading time schedule, whether the current running time is the start time point of the target time unit, comprises:
querying a market opening time corresponding to the resource category of the running object from the resource category trading time schedule;
acquiring a first duration between the current running time and the market opening time; and
in a case where the target time unit multiplied by N equals the first duration, determining that the current running time is the start time point of the target time unit, and N being a positive integer greater than or equal to 1.

15. A non-transitory computer-readable storage medium, storing a computer program, wherein the computer program, when executed by a processor, implements a market data processing method, and the market data processing method comprises:
in response to a running operation of a target quantitative strategy, acquiring a current running time, a running object in the target quantitative strategy, and a target time unit of market data subscribed in the target quantitative strategy;
acquiring a resource category of the running object, and determining, based on the target time unit, the resource category, and a resource category trading time schedule, whether the current running time is a start time point of the target time unit;
in a case of determining that the current running time is the start time point of the target time unit, acquiring first market data of the running object with the target time unit from cached data;
in a case where the first market data is not real-time market data of the running object on the target time unit at the current running time, acquiring second market data of the running object with a candidate time unit at the current running time from the cached data, and constructing the real-time market data of the running object on the target time unit at the current running time based on the second market data; and
performing the target quantitative strategy based on the real-time market data of the running object on the target time unit at the current running time.

16. The non-transitory computer-readable storage medium according to claim 15, wherein the market data processing method further comprises:
in a case where the current running time is not the start time point of the target time unit, acquiring the first market data of the running object with the target time unit from the cached data;
determining the first market data as the real-time market data of the running object on the target time unit at the current running time; and
performing the target quantitative strategy based on the real-time market data of the running object on the target time unit at the current running time.

17. The non-transitory computer-readable storage medium according to claim 15, wherein market data processing method further comprises:
in a case of not acquiring the second market data of the running object and the candidate time unit at the current running time from the cached data, entering a waiting state until acquiring the real-time market data of the running object on the target time unit at the current running time, and performing the target quantitative strategy based on the real-time market data of the running object on the target time unit at the current running time; or
in a case of not acquiring the second market data of the running object and the candidate time unit at the current running time from the cached data, entering the waiting state until acquiring third market data of the running object and the candidate time unit at the current running time, constructing the real-time market data of the running object on the target time unit at the current running time based on the third market data, and performing the target quantitative strategy based on the real-time market data of the running object on the target time unit at the current running time.

18. The non-transitory computer-readable storage medium according to claim 17, wherein entering the waiting state comprises:
starting timing and repeatedly detecting whether the real-time market data of the running object on the target time unit at the current running time exists; in a case where the real-time market data of the running object on the target time unit at the current running time exists, determining that the real-time market data of the running object with the target time unit at the current running time has been acquired; or
starting timing and repeatedly detecting whether the third market data of the running object with the candidate time unit at the current running time exists; in a case where the third market data of the running object with the candidate time unit at the current running time exists, determining that the third market data of the running object with the candidate time unit at the current running time has been acquired.

19. The non-transitory computer-readable storage medium according to claim 17, wherein market data processing method further comprises: in a case of detecting that a duration of entering the waiting state has exceeded a preset duration, ending the waiting state, taking the first market data as the real-time market data of the running object on the target time unit at the current running time, and performing the target quantitative strategy based on the real-time market data of the running object on the target time unit at the current running time.

20. The non-transitory computer-readable storage medium according to claim 15, wherein determining, based on the target time unit, the resource category, and the resource category trading time schedule, whether the current running time is the start time point of the target time unit, comprises:
querying a market opening time corresponding to the resource category of the running object from the resource category trading time schedule;
acquiring a first duration between the current running time and the market opening time; and
in a case where the target time unit multiplied by N equals the first duration, determining that the current running time is the start time point of the target time unit, and N being a positive integer greater than or equal to 1.
